(19) United States
(12) Patent Application Publication
(10) Pub. No.: US 2025/0388270 A1
(43) Pub. Date: Dec. 25, 2025

(54) ANTI-ROTATION STRUCTURE

(71) Applicant: FCA US LLC, Auburn Hills, MI (US)

(72) Inventors: Zuezhong Fu, Shanghai (CN); Wei Fang, Shanghai (CN); Bo Han, Shanghai (CN); Zhongyun Feng, Shanghai (CN); Huan Jun Jiang, Shanghai (CN)

(21) Appl. No.: 18/751,889

(22) Filed: Jun. 24, 2024

(51) Int. Cl. B62D 25/14

(52) U.S. Cl. CPC B62D 25/145

(57) ABSTRACT

An anti-rotation structure includes a first elongated member including an outer surface having a first extension extending therefrom and a second extension extending therefrom. A second member is coupled to the first extension and is coupled to the second extension. The second member has a rib disposed against the outer surface.

### FIELD

The present disclosure relates to automotive vehicles and, more specifically, to an anti-rotation structure that prevents components from rotating relative to each other during assembly.

### BACKGROUND

This section provides background information related to the present disclosure which is not necessarily prior art.

Anti-rotation structures are used in automobiles to prevent structures from moving relative to each other during assembly or other working processes. Anti-rotation structures typically have three points of contact to prevent rotation. Typically, two points of contact are adjacent to one structure while a third point of contact is significantly spaced apart from the other. Preventing rotation of certain components is important during the assembly process. Space in automotive vehicles is very limited, particularly behind an instrument panel. Providing anti-rotation structures that have reduced space requirements is important.

### SUMMARY

This section provides a general summary of the disclosure, and is not a comprehensive disclosure of its full scope or all of its features.

In one aspect of the disclosure, an anti-rotation structure includes a first elongated member including an outer surface having a first extension extending therefrom and a second extension extending therefrom. A second member is coupled to the first extension and is coupled to the second extension. The second member has a rib disposed against the outer surface.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front view of an instrument panel of a vehicle mounted using the anti-rotation structure.

FIG. 2 is an inside view of the instrument panel of FIG. 1.

FIG. 3A is a perspective view of the second member of the anti-rotation structure.

FIG. 3B is a side elevational view of the second member.

FIG. 3C is a cross-sectional view through a rib of the second member.

FIG. 3D is a cross-sectional view of the second member adjacent to a rib.

FIG. 3E is an assembled view of the anti-rotation structure.

FIG. 3F is a cross-sectional view of the anti-rotation structure coupled o a rib.

FIG. 3G is a cross-sectional view of the anti-rotation structure through an extension of the first member with a tab of the second member extending therethrough.

FIG. 3H is an enlarged cutaway view of the second member relative to the first elongated member and the first extension.

FIG. 3I is a cross-sectional view of the first extension through the tab and the opening in the first extension.

Corresponding reference numerals indicate corresponding parts throughout the several views of the drawings.

### DETAILED DESCRIPTION

Example embodiments will now be described more fully with reference to the accompanying drawings.

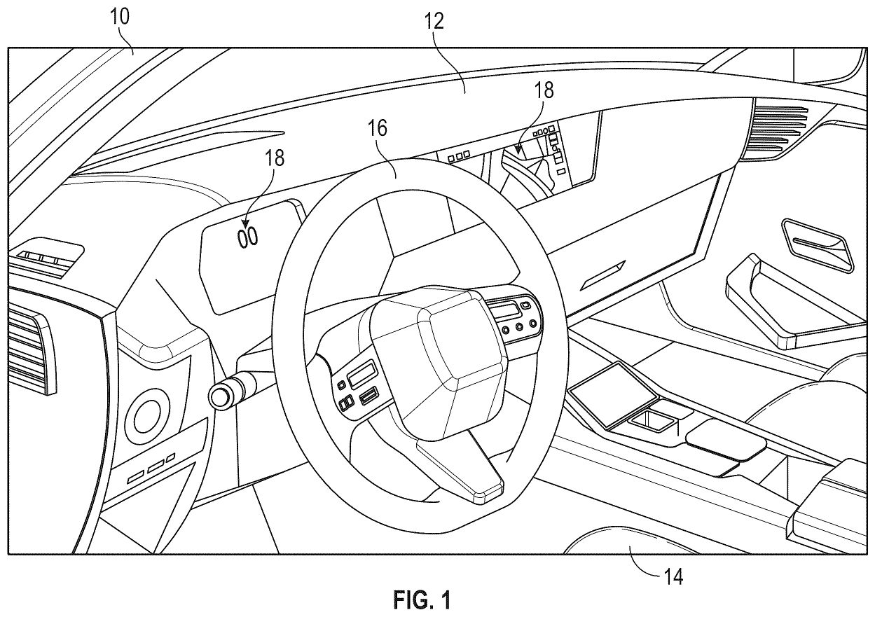

Referring now to FIG. 1, a portion of a vehicle 10 is illustrated. The vehicle 10 has an instrument panel 12 that is shown from the perspective of a driver seat 14. The vehicle 10 also includes a steering wheel 16 that is mounted within or adjacent to the instrument panel 12. The instrument panel 12 includes displays 18 that are used for displaying various data including navigation data, vehicle data, climate control data and the like. The instrument panel 12 typically includes a storage compartment and safety features such as airbags and the like.

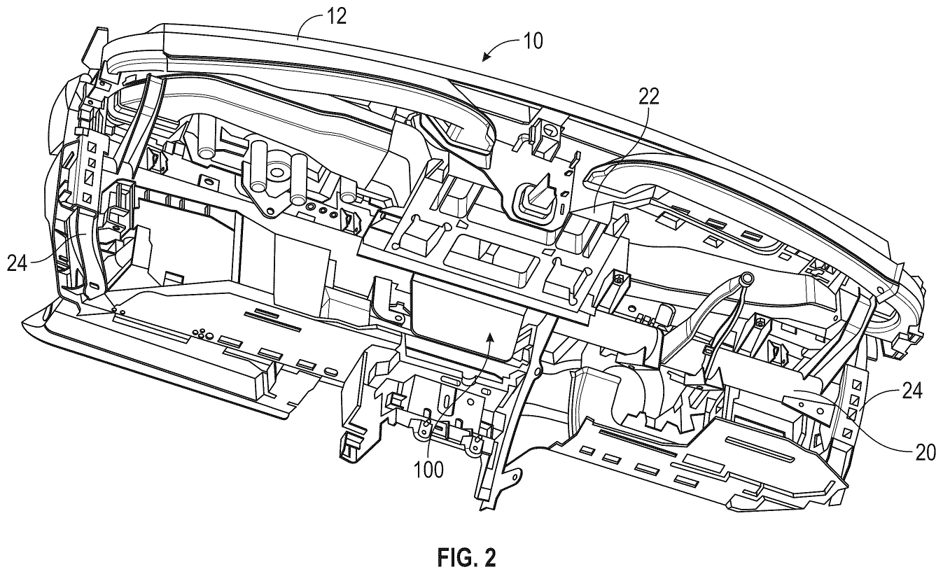

Referring now to FIG. 2, the opposite or unfinished side of the instrument panel 12 is illustrated. The instrument panel 12 has a cross vehicle beam that forms a first elongated member 20 that extends across the instrument panel 12 along the backside. The instrument panel 12 is secured to the vehicle by a second member 22. The first elongated member 20 and second member 22 forms an anti-rotation structure 100. The second member 22 is used for securing the instrument panel 12 to the vehicle structure. The instrument panel 12 also has support structures 24 extending generally vertically in this example. The supports 24 form a frame so that the instrument panel 12 may be moved into the position within the vehicle 10.

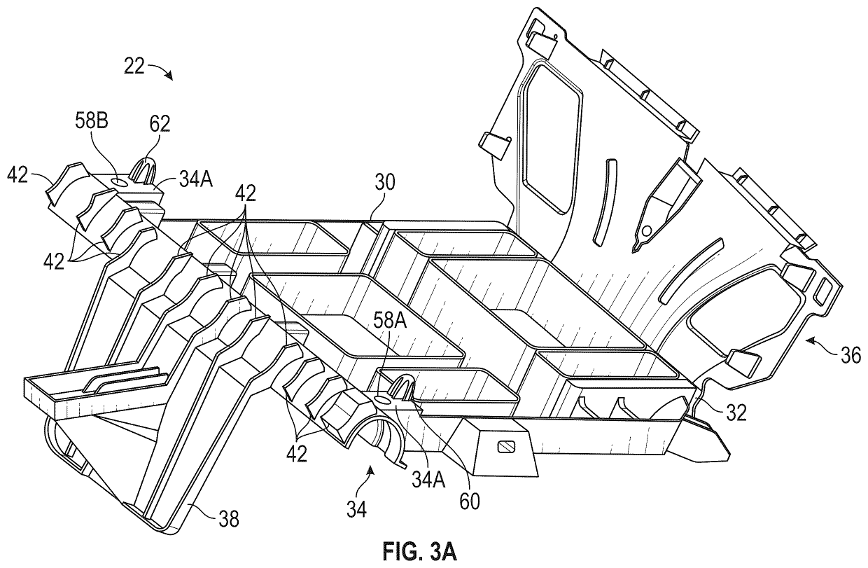

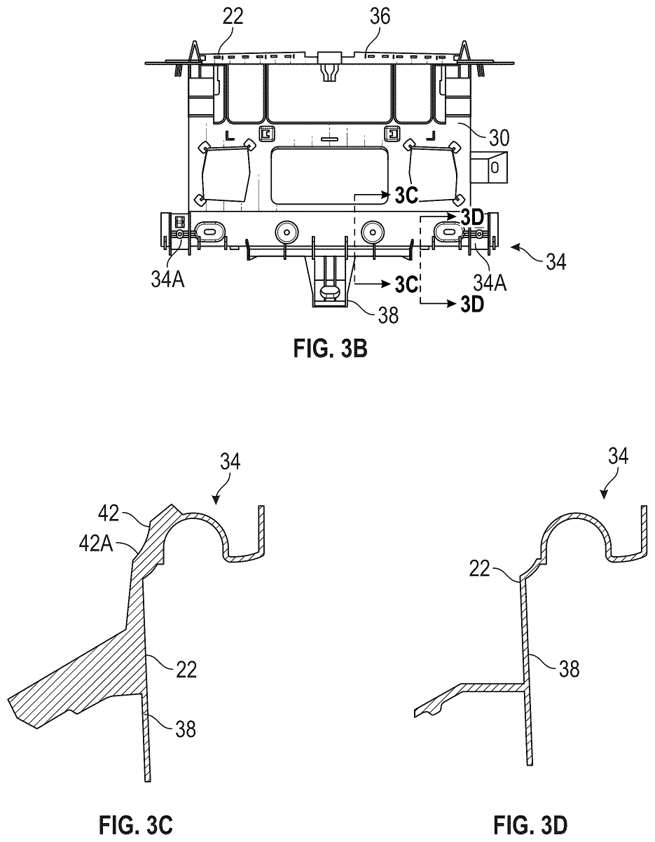

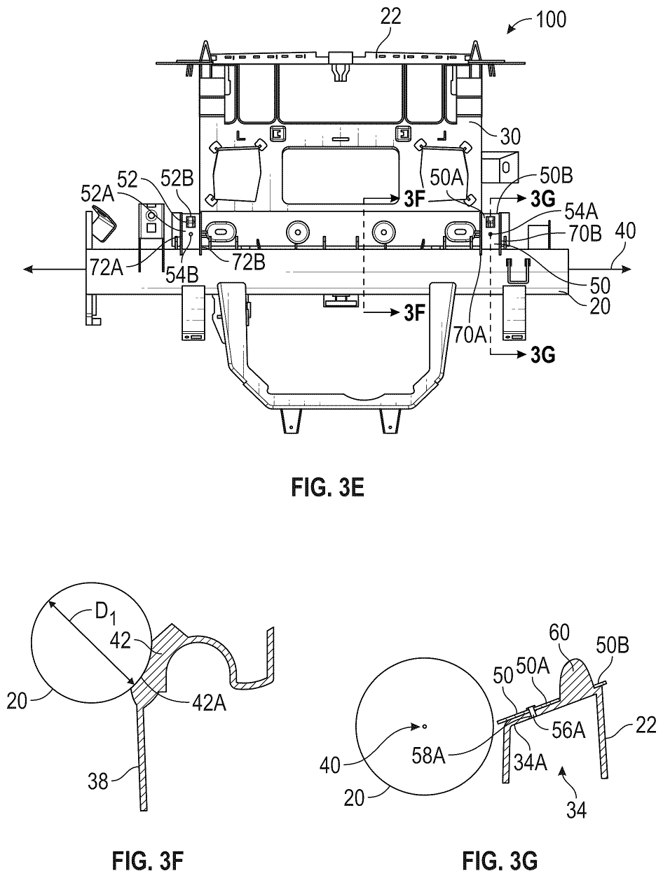

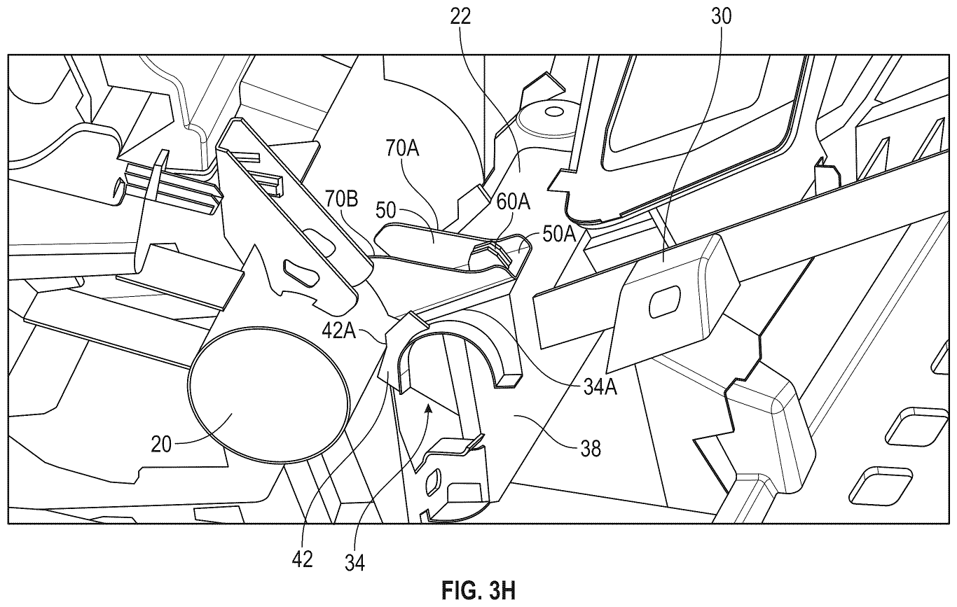

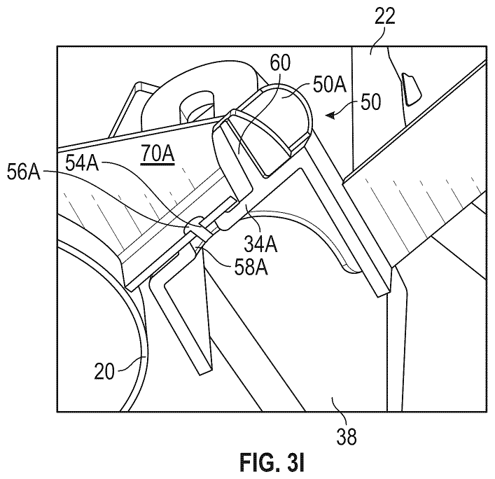

The second member 22 is positioned relative to the cross vehicle beam 20 so that the second member 22 does not rotate making installation of the instrument panel 12 easier during the assembly process. Typically, the assembled instrument panel 12 is positioned into the vehicle by an assembly worker with the assist of a robot. During coupling, it is desirable to prevent the second member 22 from moving relative to the cross vehicle beam or first elongated member 20. In FIGS. 3A-3D, a first portion 30 has a first end 32 and a second end 34. The first portion 30 is generally planar and is shaped based upon the function. In this example, various openings and the like are provided. The first portion has a first end 32 with a second portion 36 extending therefrom. The second end 36 has a third portion 38 extending therefrom. In this example, the second portion 36 extends in the opposite direction to that of the third portion 38.

The cross vehicle beam or first elongated member 20 is placed adjacent to a planar portion 34A of the second end 34 of the first portion 30. As illustrated in FIG. 3E, the first elongated member 20 has a longitudinal axis 40. The second end 34 has a plurality of ribs 42 extending therefrom. The ribs 42 are generally planar in shape and have a curved edge. The ribs 42 are perpendicular or normal to the longitudinal axis 40 of the first elongated member 20. The curved surface 42A, in this example, corresponds to the outer surface of the first elongated member 20. That is, as best illustrated in FIGS. 3F and 3G, the first elongated member 20 has a diameter D1.

The first elongated member 20 has a first extension 50 and a second extension 52. The first extension 50 and the second extension 52 extend in a generally radial direction as best illustrated in FIG. 3G. The first extension 50 has a planar portion 50A and the second extension 52 has a second planar portion 52A. The planar portions 50A, 52A have openings 50B, 52B, respectively. The openings 50B, 52B receive tabs 60, 62, respectively that extend from the planar portions 34A of the second end 34. The tabs 60 extend from the second end 34 of the first portion 30. When assembled the planar portions 34A are directly adjacent to the planar portions 50A, 52A.

The first extension 50 and the second extension 52 have openings 54A, 54B, respectively. The openings 54A, 54B receive fasteners 56A, 56B. The fasteners 56A, 56B extend into the second end 34. In particular, the second end 34 has openings 58A, 58B that receive the respective fasteners 56A, 56B. The first extension 50 and the planar portion 50A, as is best illustrated in FIGS. 3H and 3I, have a first support flange 70A, 70B and the second extension 52 has a first support flange 72A and a second support flange 72B. The support flanges 70A, 70B, 72A, 72B are generally planar in shape and extend in a direction normal to the respective planes of the planar portions 50A, 52A. In this example, the support flanges 70A, 70B, 72A, 72B are generally triangular in shape and extend from the first elongated member 20 to the end of the respective first extension 50 and the second extension 52, respectively.

In operation, the second member 22 has the tabs 60, 62 inserted into the openings 54A, 54B, respectively. Fasteners 56 are screwed through the openings 54A, 58A and 54B, 58B to draw the planar portions 34A to the planar portions 50A, 52A. The ribs 42 are placed adjacent to the first elongated member 20. The forces on the member 22 are counteracted by the ribs 42, the first extension 50 and the second extension 52. No fastening is required at the second end 32 to hold the second member 22 in position relative to the first elongated member 20. The second member 22 is positioned between the supports 24. In this example, the member 22 is centered on the first elongated member 20 between the supports 24.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An anti-rotation structure comprising:
a first elongated member comprising an outer surface having a first extension extending therefrom and a second extension extending therefrom; and
a second member coupled to the first extension and coupled to the second extension, said second member comprising a rib disposed against the outer surface.

2. The anti-rotation structure of claim 1 wherein the first extension and the second extension extend radially from the first elongated member.

3. The anti-rotation structure of claim 2 wherein the first extension comprises a first planar portion, and the second extension comprises a second planar portion.

4. The anti-rotation structure of claim 3 wherein the first extension comprises a first support flange extending between the first planar portion and the first elongated member and the second extension comprises a second support flange extending between the second planar portion and the first elongated member.

5. The anti-rotation structure of claim 4 wherein the first extension comprises a third support flange extending between the first planar portion and the first elongated member and the second extension comprises a fourth support flange extending between the second planar portion and the first elongated member.

6. The anti-rotation structure of claim 3 wherein the first extension comprises a first opening, said second member comprising a first tab extending therefrom and received in the first opening.

7. The anti-rotation structure of claim 4 wherein the second extension comprises a second opening, and the second member comprises a second tab extending from a received in the second opening.

8. The anti-rotation structure of claim 7 wherein the first opening is disposed through the first planar portion and the second opening is disposed through the second planar portion.

9. The anti-rotation structure of claim 8 further comprising a third opening disposed through the first planar portion and a fourth opening is disposed through the second planar portion.

10. The anti-rotation structure of claim 9 further comprising a first fastener received in the third opening and coupled to the second end, and a second fastener received in the fourth opening and coupled to the second end.

11. The anti-rotation structure of claim 1 wherein the rib is normal to the first elongated member.

12. The anti-rotation structure of claim 1 wherein the rib comprises a plurality of ribs.

13. The anti-rotation structure of claim 12 wherein the plurality of ribs is normal to a longitudinal axis of the first elongated member.

14. The anti-rotation structure of claim 1 wherein the outer surface comprises a curved surface.

15. The anti-rotation structure of claim 14 wherein the rib comprises a plurality of ribs shaped to correspond to the curved surface of the first elongated member.

16. The anti-rotation structure of claim 1 wherein the first elongated member comprises a cross vehicle beam.

17. A vehicle comprising:
an instrument panel;
the anti-rotation structure of claim 1;
wherein the first member comprises a cross vehicle beam.

18. The vehicle of claim 17 wherein the cross vehicle beam is coupled to the instrument panel.

19. The vehicle of claim 17 wherein the second member is coupled between a first support and a second support.
